(19) United States
(12) Patent Application Publication
(10) Pub. No.: US 2011/0166787 A1
(43) Pub. Date: Jul. 7, 2011

(54) METHODS AND SYSTEMS FOR LOCATING WIND TURBINES

(75) Inventors: Russell M. TENCER, New York, NY (US); Glenn D. SCHUYLER, Paris (CA)

(73) Assignee: WIND PRODUCTS INC., New York, NY (US)

(21) Appl. No.: 12/985,837

(22) Filed: Jan. 6, 2011

Related U.S. Application Data
(60) Provisional application No. 61/292,733, filed on Jan. 6, 2010.

(51) Int. Cl. G01W 1/02; G06F 19/00

(52) U.S. Cl. 702/3

(57) ABSTRACT

Methods and systems for providing wind energy density for a location, for example, for locating a wind turbine at the location are provided. The method includes the steps of a) providing a location for consideration; b) identifying at least one meteorological station, for example, nearest the location; c) determining a wind speed for the at least one meteorological station; d) determining surface roughness characteristics of an area around the at least one meteorological station; e) calculating geostrophic wind speed about an area around the at least one meteorological station from the wind speed and the surface roughness characteristics of an area around the at least one meteorological station; f) determining surface roughness characteristics of an area around the location; and g) calculating a wind energy density for the area about the location from the calculated geostrophic wind speed and the surface roughness characteristics of the area around the location.

### CROSS-REFERENCE TO RELATED APPLICATION

This application claims priority from pending U.S. Provisional Patent Application 61/292,733, filed on Jan. 6, 2010, the disclosure of which is included by reference herein in its entirety.

### BACKGROUND OF THE INVENTION

1. Field of the Invention

The present invention relates, generally, to methods and systems for providing localized wind energy assessments, particularly, to user-friendly, automated methods and systems that provide micro-level wind energy densities for localized areas, for example, urban or suburban areas.

2. Description of Related Art

In the early 21^{st} century, the acute recognition of the decline in the availability of fossil fuels and the limitation of fossil fuels for providing global energy needs continues to direct attention to the development of alternate energy sources. One source of renewable energy receiving increased attention is the plentiful and renewable supply of wind energy, that is, the conversion of wind energy to electrical energy from the rotation of wind turbines powered by wind.

The proper positioning of the wind turbine is often critical to effective and efficient harvesting of wind energy. In particular, the position of a wind turbine in an urban, suburban, or rural area can be complicated by the presence of landscape, buildings, and/or structures that may affect the wind energy or wind energy density available in an area. Examination of prior art methods, including onsite observations, wind maps, anemometer readings, computational fluid dynamics (CFD) analysis, light detection and ranging (LIDAR), and sonic detection and ranging (SODAR), reveals disadvantages or limitations for determining wind local energy profiles. For example, existing methods of estimating or mapping wind energy patterns are often crude and not sufficiently precise to estimate local wind energy distributions, for example, “micro-climate” effects causing, for example, turbulence, blocking, or speed up, for instance, about trees, hills, mountains, and valleys, as well as, about buildings and structures.

LIDAR and SODAR methods employ measurement devices, in a manner similar to anemometers, which may effectively detect and record wind data, but LIDAR and SODAR methods required that data be logged for at least 2 years to get an accurate assessment of a projected 20-year wind turbine power potential. In addition to the unacceptably long data recording times, LIDAR and SODAR methods are typically supplemented by modeling tools, such as, wind maps and/or CFD, to obtain long term wind energy histories. Aspects of the present invention also provide excellent data sets upon which to correlate the data obtained by LIDAR and SODAR methods.

Aspects of the present invention provide methods and systems for estimating wind energy or wind energy densities in localized areas, for example, those impacted by adjacent surface roughness due to natural land features and/or man-made structures and/or land features. For example, aspects of the present invention may be used to locate one or more wind turbines to optimize the energy that can be harvested from local wind patterns.

### SUMMARY OF ASPECTS OF THE INVENTION

Utilizing real world meteorological data, for example, from airports, and then factoring for topography, roughness, speeding, blocking, and other local effects, embodiments of the present invention provide wind speed and wind energy estimates for localized areas, for example, down to areas of about 10 square meters or less, for example, down to about one square meter, for instance, for “micro climates.” These wind parameters can assist in optimizing the position of, among other structures, wind turbines. Embodiments of the invention are marketed under the trademark WIND ANALYTICS™ by Wind Products Inc. of New York, N.Y.

One embodiment of the present invention is a method for locating a wind turbine comprising or including a) providing a location for consideration for locating a wind turbine; b) identifying at least one meteorological station; c) determining a wind speed for the at least one meteorological station; d) determining surface roughness characteristics of an area around the at least one meteorological station; e) calculating a geostrophic wind speed about the at least one meteorological station from the wind speed for the at least one meteorological station and the surface roughness characteristics of an area around the at least one meteorological station; f) determining surface roughness characteristics of an area around the location; g) calculating a wind speed for the area about the location from the calculated geostrophic wind speed and the surface roughness characteristics of the area around the location; and h) locating the wind turbine at a position in the area of the location based upon the calculated wind speed for the area about the location to optimize exposure of the wind turbine to wind speed.

In one aspect, the method may further comprise, after f), i) determining a local wind speed correction factor, for example, based upon wakes produced from upwind structures, and wherein g) comprises calculating the wind energy density from the calculated geostrophic wind speed, the surface roughness characteristics and the local wind speed correction factor. In one aspect, step a) providing a location may be practiced by automated means, for example, over the Internet. In another aspect, the method may also include the further step, after g), j) displaying the calculated wind energy density for the area about the location, for example, as a polar energy density distribution plot. In one aspect, the step of a) providing a location for consideration for locating a wind turbine may comprise providing an Internet-accessible user interface for identifying the location, for example, providing a user-movable cursor adapted to identify the location on a map.

Another embodiment of the invention is a system for locating a wind turbine comprising or including: a user interface for providing a location for consideration for locating a wind turbine; means for identifying at least one meteorological station; means for determining a wind speed for the at least one meteorological station; means for determining surface roughness characteristics of an area around the at least one meteorological station; a data processor programmed to calculate a geostrophic wind speed about the at least one meteorological station from the wind speed and the surface roughness characteristics of an area around the at least one meteorological station; means for determining surface roughness characteristics of an area around the location; a data processor programmed to calculate a wind speed and/or wind energy density in the area about the location from the calculated geostrophic wind speed and the surface roughness characteristics of the area around the location; and means for locating the wind turbine at a position in the area of the location to optimize exposure of the wind turbine to calculated wind speed and/or wind energy density.

In one aspect, the system may further comprise means for determining a local wind speed correction factor, for example, based upon wakes produced from upwind structures, and wherein the data processor is adapted to calculate the wind speed and/or wind energy density from the calculated geostrophic wind speed, the surface roughness characteristics, and the local wind speed correction factor. In another aspect, the user interface may be an automated user interface, such as, the Internet. In another aspect, the system may further include an output means, for example, a display, configured to display the calculated wind energy density for the area about the location. In another aspect, the automated user interface may comprise an Internet-accessible user interface for identifying the location, for example, a user-movable cursor adapted to identify the location on a map.

A further embodiment of the invention is a method for providing wind energy density for a location, the method comprising or including the steps of a) providing a location for consideration; b) identifying at least one meteorological station; c) determining a wind speed for the at least one meteorological station; d) determining surface roughness characteristics of an area around the at least one meteorological station; e) calculating a geostrophic wind speed about the at least one meteorological station from the wind speed for the at least one meteorological station and the surface roughness characteristics of an area around the at least one meteorological station; f) determining surface roughness characteristics of an area around the location; and g) calculating a wind energy density for the area about the location from the calculated geostrophic wind speed and the surface roughness characteristics of the area around the location.

A further embodiment of the invention is a system for providing wind energy density for a location, the system comprising or including a user interface for providing a location for consideration; means for identifying a meteorological station; means for determining a wind speed for the meteorological station; means for determining surface roughness characteristics of an area around the meteorological station; a data processor programmed to calculate a geostrophic wind speed about the at least one meteorological station from the wind speed and the surface roughness characteristics of an area around the at least one meteorological station; and means for determining surface roughness characteristics of an area around the location; a data processor programmed to calculate a wind energy density in the area about the location from the calculated geostrophic wind speed factor and the surface roughness characteristics of the area around the location. The data processors may be the same data processor.

A still further embodiment of the invention is a method for locating a wind turbine comprising or including providing a location for consideration for locating a wind turbine; calculating a wind energy density for an area about the location from a geostrophic wind speed in the area and characteristics of the area around the location; and locating the wind turbine at a position in the area of the location based upon the calculated wind energy density for the area about the location to optimize exposure of the wind turbine to wind energy.

A further embodiment of the invention is a system for locating a wind turbine comprising or including a user interface for providing a location for consideration for locating a wind turbine; a data processor programmed to calculate a wind energy density in the area about the location from a geostrophic wind speed in the area and characteristics of the area around the location; and means for locating the wind turbine at a position in the area of the location to optimize exposure of the wind turbine to wind energy. The means for locating may simply be manual or automated means for installing the wind turbine.

A still further embodiment of the invention is a method for providing wind energy density for a location, the method comprising or including providing a location for consideration; and calculating a wind energy density for an area about the location from a geostrophic wind speed in the area and characteristics of the area around the location.

A further embodiment of the invention is a system for providing wind energy density for a location, the system comprising or including a user interface for providing a location for consideration; a data processor programmed to calculate a wind energy density in an area about the location from a geostrophic wind speed in the area and characteristics of the area around the location.

Embodiments of the invention may provide methods and systems that further comprise ancillary information in support of wind turbine selection and installation siting, for instance, wind turbine power curves, foundation loadings, soil structures, noise levels, incentive programs, and local zoning laws.

Details of these embodiments and aspects of the invention, as well as further aspects of the invention, will become more readily apparent upon review of the following drawings and the accompanying claims.

### BRIEF DESCRIPTION OF THE FIGURES

The subject matter that is regarded as the invention is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a schematic flow chart for a method and system according to aspects of the present invention.

FIG. 2 is a schematic flow chart for a typical analysis module that can be provided for the flow chart of the method and system shown in FIG. 1.

FIG. 3 is a schematic illustration of a calculation procedure that may be performed by the analysis module shown in FIG. 1.

FIG. 4 illustrates one graphical user interface that may be used for aspects of the invention.

FIG. 5 illustrates another graphical user interface resulting from the location information input to the interface shown in FIG. 4 that may be used for aspects of the invention.

FIG. 6 illustrates one graphical user interface that may be used for aspects of the invention in which the user defines the land use classification about a target site.

FIG. 7 illustrates one graphical user interface that may result from the user defined land use classifications provided in FIG. 6.

FIG. 8 illustrates one graphical user interface that may be used for aspects of the invention for the user to define the size and location of natural and/or man-made structures about the target site.

FIG. 9 illustrates one graphical output display that may be used for aspects of the invention.

### DETAILED DESCRIPTION OF FIGURES

The details and scope of aspects of the present invention can best be understood upon review of the attached figures and their following descriptions.

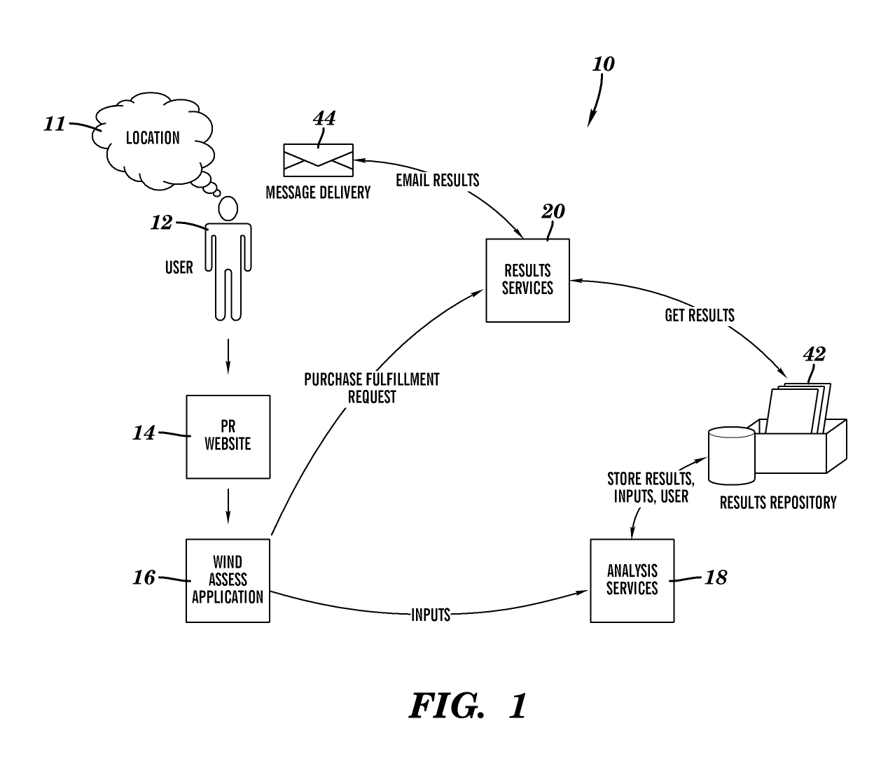

FIG. 1 is a schematic flow chart for a method and system 10 for providing wind energy density and/or prevailing winds for a location, for example, for locating a wind turbine, according to aspects of the present invention. The method and system 10 shown in FIG. 1 may be used to provide wind energy density for a location, for example, to assist in optimally locating a wind turbine. Though a wind turbine is not shown in FIG. 1, it will be understood by those of skill in the art that any wind turbine may be located, for example, optimally located, by practicing aspects of the invention, including horizontal axis wind turbines (HAWT), vertical axis wind turbines (VAWT), or any other type of wind turbine. For example, in one aspect, methods and systems 10 may be used to locate the VAWT disclosed in co-pending U.S. application ABC filed on January XY, 2011 (attorney ref. 3313.005A), the disclosure of which is incorporated by reference herein in its entirety.

According to aspects of the invention, as shown in FIG. 1, a location under consideration is first established, for example, a user 12 may desire to determine the wind energy density at a specific location 11, for example, to locate a wind turbine. User 12, for example, an individual, may access a user interface 14, for example, a computer accessing the Internet, to establish communication with a data processor 16, for example, one or more servers having software configured to communicate and prompt user 14 for information. Data processor 16 may be configured to provide a series of graphical user interfaces (GUI) to prompt user 12 for information, for example, user identifying information, user defined project information, and the location 11 for which wind energy density is desired. The location 11 may be supplied by address, for example, street address and zip code, by longitude and latitude, by a GPS sensing (for example, from an actual physical location), or by means of graphical interface and cursor. The location 11 may also be established by interpolation or extrapolation, for example, by geometry, from two or more positions. In addition to receiving a location 11 from user 12, processor 16 may also be configured to receive other data and parameters associated with user 12 and the location 11, for example, the user's reference or descriptive information.

As shown in FIG. 1, in addition to interfacing with user 12, processor 16 may also communicate with a data analysis module 18 and a results and accounting module 20 via conventional communication protocols. For example, analysis module 18 and accounting module 20 may reside in the same processor or server 16, but, typically, analysis module 18 and accounting module 20 may reside remotely of processor 16 and communicate with processor 16, for example, over the Internet or via a dedicated communications bus. Accounting module 20 may be configured to accept user account information, purchase order information, and provide user invoices, among other functions.

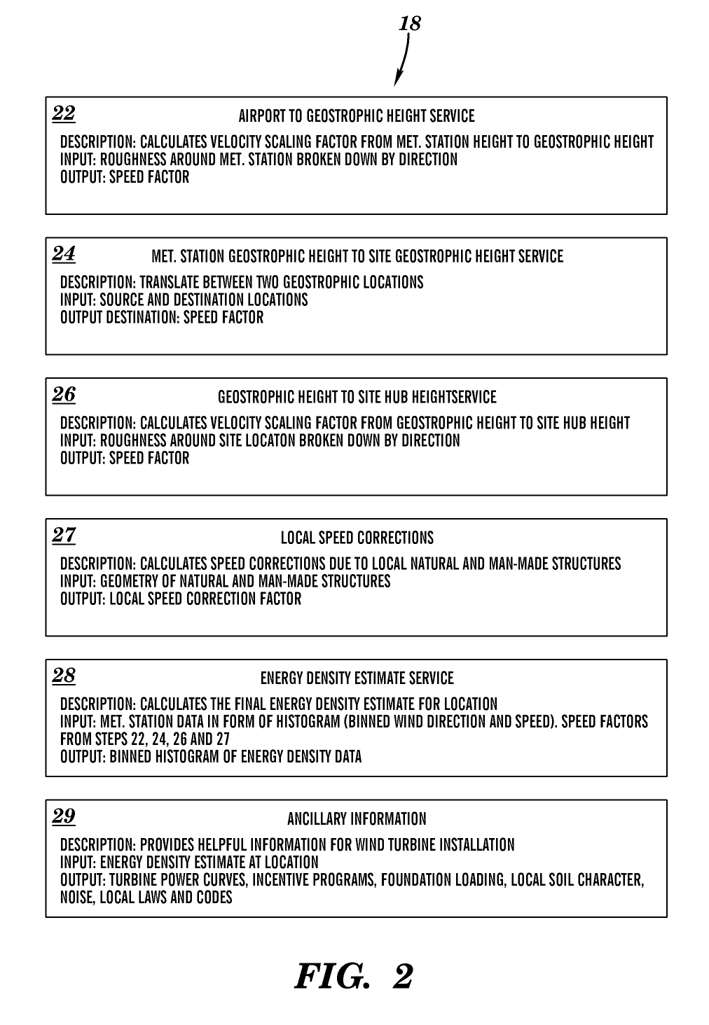

According to aspects of the invention, analysis module 18 receives information from user 12 via processor 16 and manipulates the data received to provide the desired wind energy density. In addition, analysis module 18 may prompt processor 16 to request information from user 12, for example, to confirm the accuracy of submitted data or prompt the user to address any inconsistencies that may be reflected in information received. Upon receipt and confirmation of the data, for example, location 11, analysis module 18 manipulates the data received with data received from other sources to provide the desired wind energy density and/or wind data, for example, in an area about the specified location 11. The details of this data manipulation are summarized in the flow chart of FIG. 2.

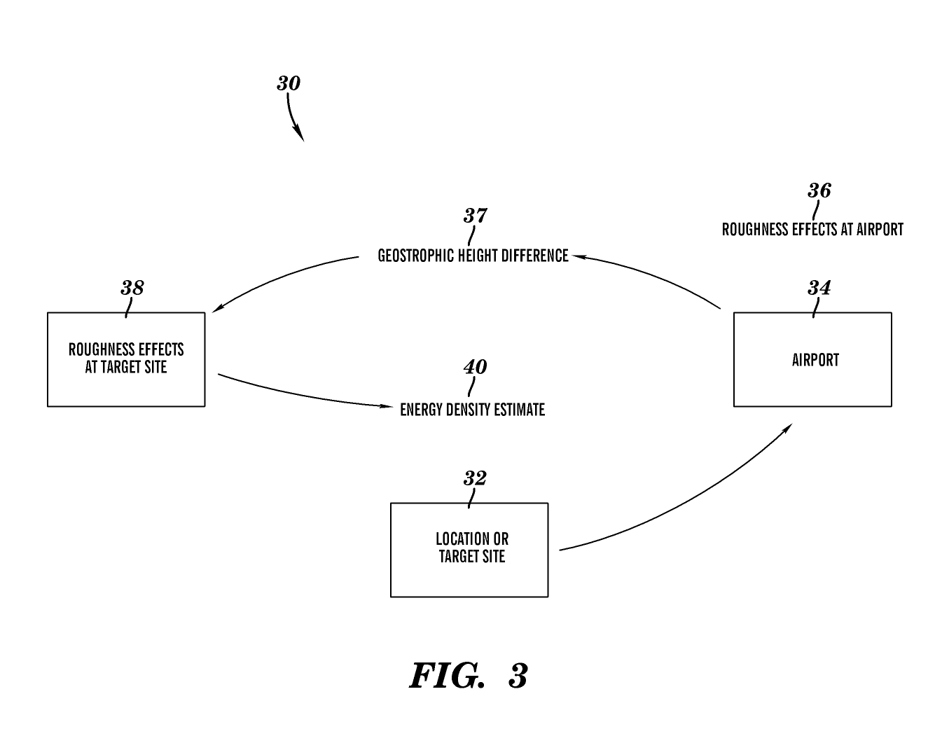

FIG. 2 is a schematic flow chart of the functions that may be performed by a typical analysis module 18 that can be provided for the flow chart 10 of the method and system shown in FIG. 1. FIG. 3 is a schematic illustration of a calculation procedure 30 that may be performed by the analysis module 18 shown in FIG. 1. As shown in FIG. 3, the location or target site 32 may typically be location 11 provided by user 12.

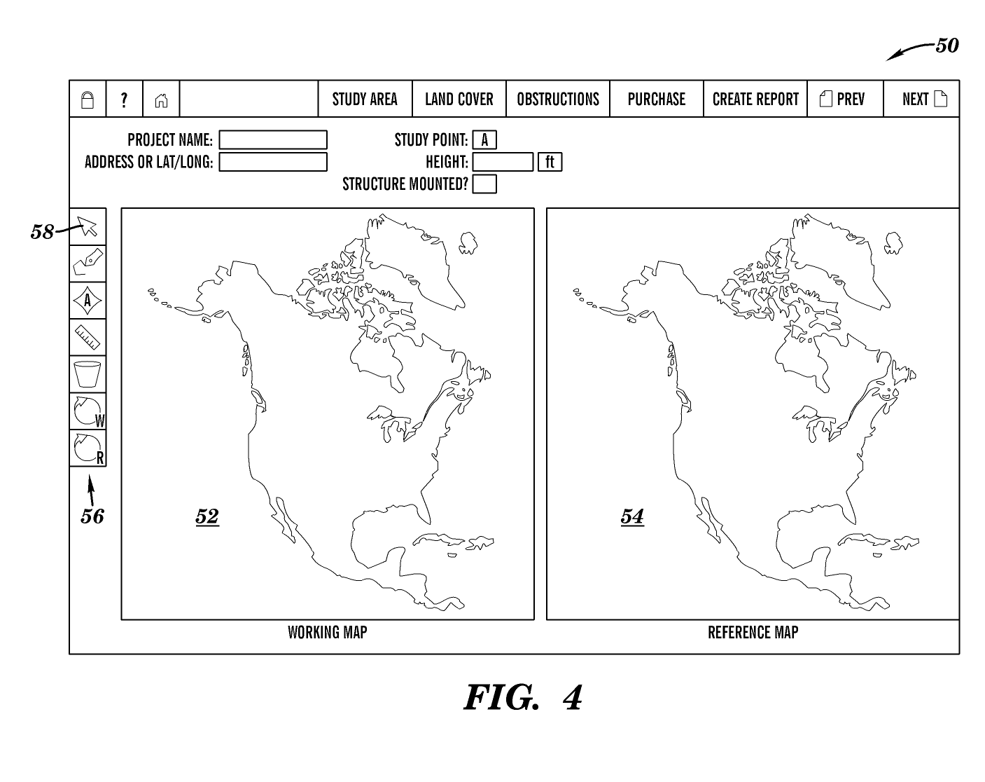

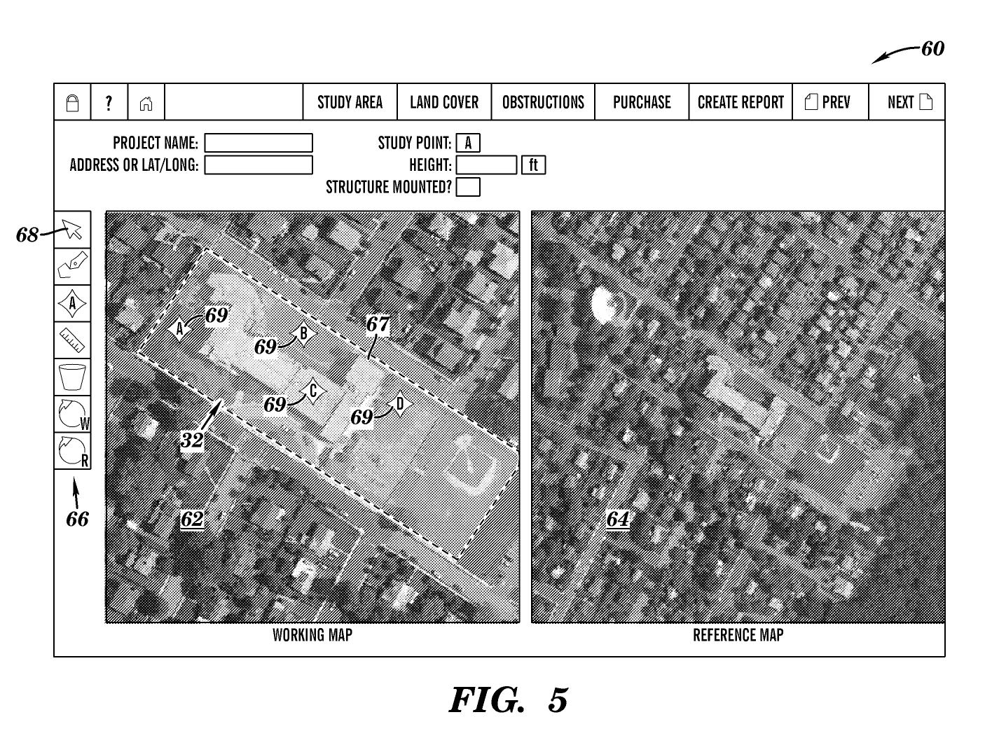

FIG. 4 illustrates one graphical user interface 50 that may be used for aspects of the invention. User interface 50, for example, an Internet-based interface, includes a working map 52, a reference map 54, and a plurality of user manipulated position locating icons 56, such as, pointer 58, to identify desired positions on working map 52. The selected positions are echoed on reference map 54. In this aspect, maps 52 and 54 comprises satellite views of North America, though views, such as satellite views, road maps, or land maps, of any other continent, country, region, state, city, or municipality may be shown to the user. FIG. 5 illustrates one graphical user interface 60 resulting from the location information input to the interface 50 shown in FIG. 4 that may be used for aspects of the invention. User interface 60 includes a working map 62, a reference map 64, and a plurality of user manipulated position locating icons 66, such as, pointer 68, to identify a specific area 67, for example, the property boundary of the project, and the desired positions 69 or “study points” (A, B, C, D . . . ) for locating, for example, a wind turbine on working map 62. The selected positions are echoed on reference map 64. Maps 62 and 64 are typically magnified views of the location identified using the user interface shown in FIG. 4.

As shown in FIG. 2, first, module 18, as indicated at step 22, identifies one or more meteorological (or simply, “met”) stations 34, for example, at one or more airports, for example, one or more meteorological stations nearest the location 32, from which to obtain wind speed data, for example, geostrophic wind speed data calculated from local wind conditions. As is known in the art, geostrophic wind speed data is the theoretical wind speed, above substantially any and all influence of surface roughness, that would result from a substantial balance between the Coriolis effect of the rotating earth and the pressure gradient force. The pressure gradient force is the horizontal projection of the vertical atmospheric pressure at a location, which is the principal source for the generation of wind. Geostrophic wind speed data may typically be provided as a function of time and direction, for example, about the 24 points of the compass.

As is known in the art, the elevation or height above the surface of the earth at which the geostrophic wind speed (again, that is substantially beyond the influence of the roughness of natural or man-made structures) is referred to as the “geostrophic height” at a location, for example, at a given longitude and latitude. In other words, the geostrophic height is the height above the earth's surface above which wind speed is not substantially influenced by surface roughness and below which the roughness of natural and man-made structures typically cause variations in wind speed. The elevation or height of this boundary layer, or the geostrophic height, may vary broadly, but is typically about 600 meters plus or minus 100 meters above the surface of the earth.

According to aspects of the invention, the boundary layer height and the geostrophic wind speed about one or more meteorological stations is used to determine the corresponding boundary layer height, geostrophic wind speed, and/or the variation in the wind speed at elevation at the desired location 32. In one aspect, a predetermined contour map or look-up table of the relative contribution of the boundary layer height of one or more meteorological stations can be used to estimate or determine the boundary layer height at the desired location 32. For example, in one aspect, contour wind probability factors, for example, based upon Weibull functions, of the one or more meteorological stations 34 near a given location 32, for example, latitude and longitude entered by the user, may be used to establish a boundary layer height at location 32. Again, the wind probability parameters will typically be contoured for each wind direction, and may be a function of elevation or height. In one aspect of the invention, a boundary layer height and/or a geostrophic wind speed at or about a meteorological station may be estimated from the prevailing wind speeds and patterns at or about the meteorological station and the characteristics of the natural and man-made surfaces and/or structures at and about the meteorological stations that may affect wind speeds and patterns.

In addition, as indicated at step 22 in FIG. 2, module 18 may calculate a velocity-scaling factor from the meteorological station height, that is, the elevation above sea level to the geostrophic height of the meteorological station (again, at which there are no effects from surface roughness). As shown in step 22, module 18 may also obtain the surface roughness characteristics, shown at 36 in FIG. 3, of the area about the meteorological station 34, for example, broken down by direction. For example, bodies of water are typically characterized as having “very low roughness,” while urban areas are typically characterized as having “high roughness.” The roughness characteristics at or about the one or more meteorological stations 34 may typically be obtained from existing, published land use data maps surrounding the one or more stations 34, for example, based upon the latitude and longitude of the stations 34. These roughness characteristics or factors may vary due to land use, for example, urban, suburban, or rural areas, and generally have values, in meters, ranging from about 0.1 meter to 2 meters, and may vary by height. As indicated in step 22 of FIG. 2, geostrophic height and the roughness at the one or more meteorological stations 34 are used to define a wind speed factor, SF_{MS}, associated with the one or more meteorological stations 34. For example, in one aspect, the roughness information is used in published boundary layer calculations to generate a power law speed and turbulence profile about the one or more stations 34, for instance, wind speed (for example, in meters per second [m/s]) at an elevation (for example, in meters [m]), typically for each of 24 wind direction sectors. Using these speed profiles, the wind speed characteristics at the one or more meteorological stations 34 are extrapolated, for example, upward, from the meteorological station height to the geostrophic height.

As indicated by step 24 in FIG. 2, analysis module 18 may then calculate the boundary layer height difference or geostrophic height difference 37 (FIG. 3) of the one or more meteorological stations 34 and the local geostrophic height of the location or target area 32 to determine a destination or location speed factor, SF_{L}. Again, in one aspect, this may be practiced by using published boundary layer calculations to determine the geostrophic height difference based on the roughness information. In one aspect of the invention, the geostrophic height and/or geostrophic wind speed at or about the one or more meteorological stations 34 may be substantially the same as the geostrophic height and/or geostrophic wind speed at or about the local location or target area 32.

As indicated by step 26 in FIG. 2, analysis module 18 may then calculate speed factor, SF_{R}, based upon the surface roughness 38 (FIG. 3) about the location or target site 32, for example, due to landscape, buildings, and structures about location 32. Surface roughness within a 10-mile radius of location 32 may be used, or within a 5-mile radius of location 32, or a 3-mile radius or less of location 32 may be used. In one aspect of the invention, in a procedure similar to that described above, the roughness information about the target site 32 and the calculated geostrophic wind speed about target area 32 may be used in published boundary layer calculations to generate a power law speed and turbulence profile for target site 32 for each of over 24 wind direction sectors, and may be a function of elevation or height. Using these speed profiles, the local wind speed characteristics at target site 32 are extrapolated, for example, down, from the geostrophic height.

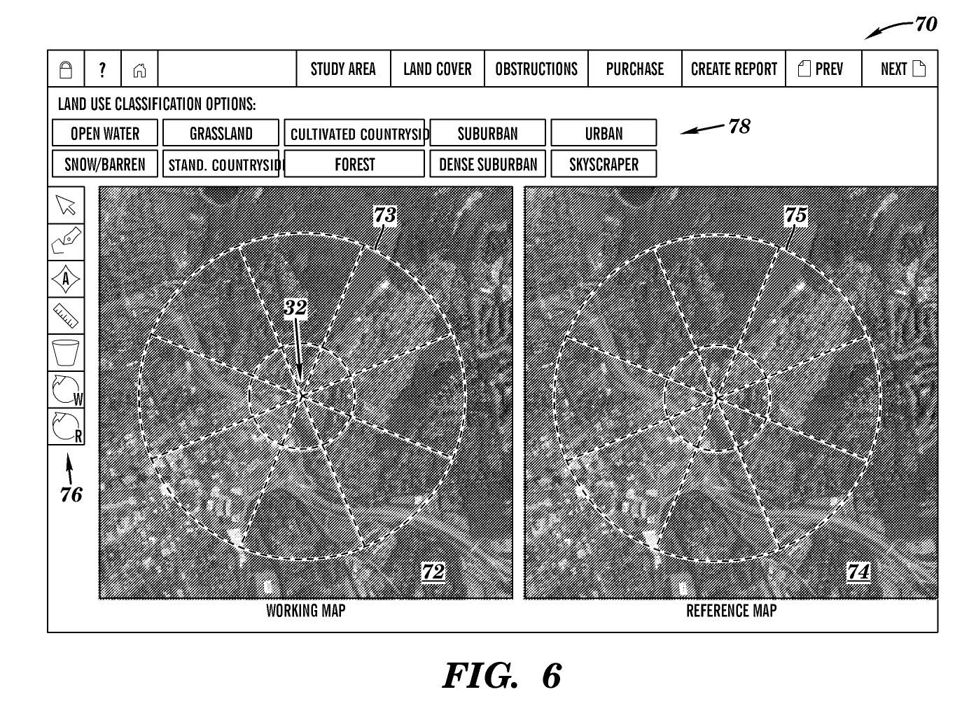

FIG. 6 illustrates one graphical user interface 70 that may be used for aspects of the invention in which the user defines the surface roughness 38 (FIG. 3) about the location or target site 32, for example, by specifying the local “land use classification” about the site 32. User interface 70, for example, an Internet-based interface, includes a working map 72, a reference map 74, a plurality of user manipulated position locating icons 76 and a plurality of “land use classifications” 78. The land use classifications 78 may include, but are not limited to, “open water,” “grassland,” “cultivated countryside,” “suburban,” “urban,” “snow/barren,” “standard countryside,” “forest,” “dense suburban,” and “skyscraper.” The land use classifications may be color coded or otherwise graphically distinguished to aid the user in differentiating the classifications. According to aspects of the invention, each land use classification may have a specific value of roughness 38 upon which to base a roughness speed factor, SF_{R}.

According to aspects of the invention, the user may interactively identify the land use classifications about location 32, for example, with keyboard input or cursor input, among other means. In one aspect, the input and identification of land use classification may be facilitated by the use of grids 73 and 75 on maps 72 and 74, respectively, about location 32. Any form of grid may be used for example, circular or polygonal, such, as square, rectangular, or pentagonal, or hexagonal grid. However, in the aspect of the invention shown in FIG. 6, grids 73 and 75 comprise circular or polar grids having circular grid lines of varying radius divided by radial lines. According to aspects of the invention, the user may associate one of the land use classifications 78 to each of the boxes of grid 73 of map 72. There resulting land use may be reflected in the grid 75 in map 74.

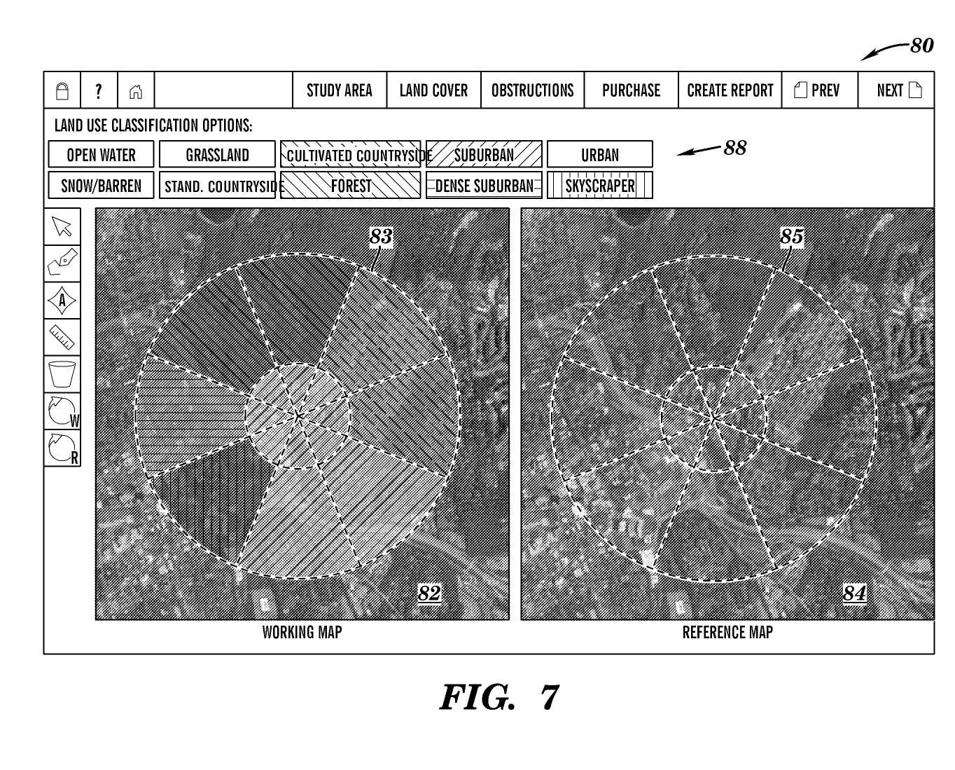

FIG. 7 illustrates one graphical user interface 80 that may result from the user defined land use classifications provided in FIG. 6. User interface 80 includes a working map 82 having grid 83, a reference map 84 having grid 85, a plurality of user manipulated position locating icons 86, and a plurality of land use classification identifying icons 88. In the aspect of the invention shown in FIG. 7, the user defined land use icons 88 are cross hatched in different patterns to suggest color coding of the boxes of grids 83 and 85 corresponding to similar cross hatchings of icons 88, though any means of graphically distinguish the boxes in grids 83 and 85 may be used.

As indicated by step 27 in FIG. 2, analysis module 18 may then calculate local speed factor, SF_{LC}, based upon the size and location of natural and/or man-made structures located locally about the location or target site 32, for example, due to landscape, buildings, and structures about location 32. For example, in one aspect of the invention, the wind speed characteristics at the height of a turbine can be corrected for effects due to local obstructions, such as, topography (for example, hills), vegetation (for example, trees), and neighboring buildings. The corrections may consist of estimates of the size of wakes behind buildings or structures when they are upwind of, for example, the turbine, for instance, existing or proposed upwind wind turbines. Corrections may vary from installation to installation and may be determined by actual or scale model testing, for example, from wind tunnel testing or computer modeling, such as, computation fluid dynamic (CFD), and/or testing of models of the terrain, structures, and structure being located, such as, a wind turbine.

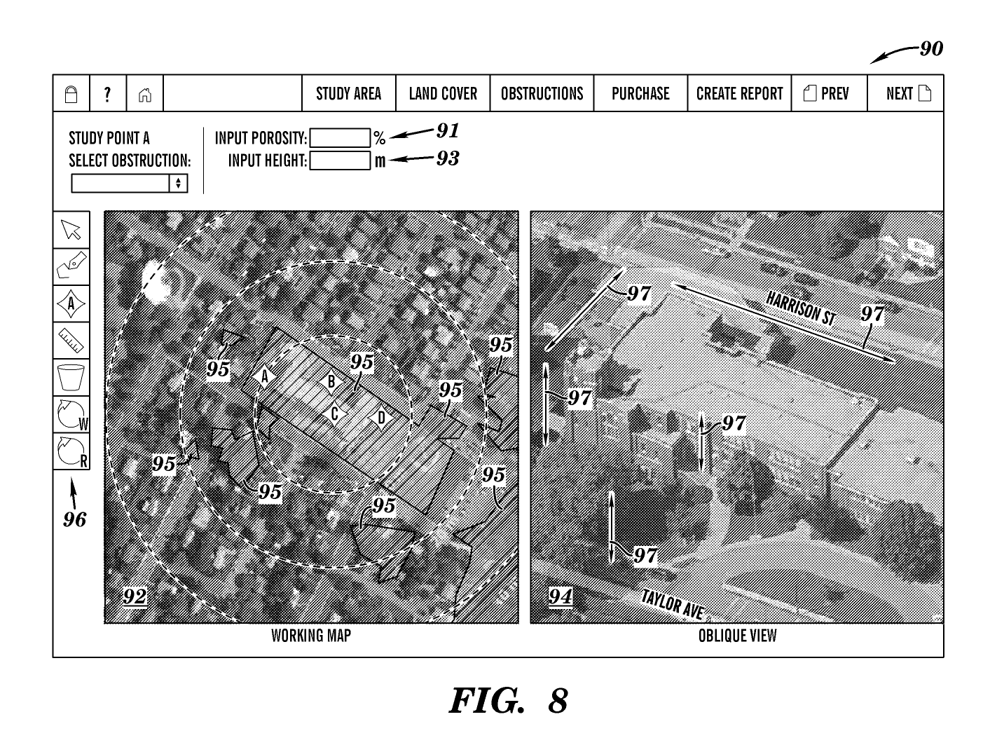

FIG. 8 illustrates one graphical user interface 90 that may be used for aspects of the invention for the user to define the size and location of natural and/or man-made structures located locally about the location or target site 32. User interface 90, for example, an Internet-based interface, includes a working map 92, a reference local map or view 94, for example, an oblique view, and a plurality of user manipulated utilities 96 for locating and/or sizing structures about target site 32. As shown in FIG. 8, user interface 90 may include one or more fields 91 and 93 for the user to specify characteristics of the structures identified, for example, structure “porosity” and structure height, for example, in meters.

According to aspects of the invention, utilities 96 may be used to identify the location of structures about site 32, for example, by outlining or drawing the shape of the structures, as indicated by the one or more polygons 95 shown in FIG. 8. In one aspect, the illustration of structures on map 92 may be used to identify the shape of structures, for example, by outlining or forming polygons 95 about the structures, for example, buildings or trees. The dimensions, for example, height and/or width, and/or depth, of the structures defined by polygons 95 may be manually input, for example, via fields 91 and/or field 93, or may be determined from the map or view 94. For example, using utilities 96, for example, a double arrow or “ruler tool,” a user my identify one or more dimensions 97 of structures associated with polygons 95 as shown in view 94 of FIG. 8.

The “porosity” of a structure provides an indication of the permeability of the structure to air flow, that is, the resistance of the structure to passing wind through the structure. The porosity is categorized as the ratio of the void area of a structure to the total surface area of a structure, for example, a building, a tree, or fence, for instance, in the direction of the wind under consideration. Porosity is defined as a percent or a decimal between 0.0 and 1.0. A solid building may have a porosity that approaches or equals 0, that is, little or no porosity, while an unobstructed area has a porosity of 1, and one or more trees may have a porosity ranging from 0.25 to 0.75, depending, for example, upon the presence of leaves on the trees. The porosity of structures can be found in references in the field.

As indicated by step 28 in FIG. 2, analysis module 18 may then calculate the energy density, E_{D}, 40 (FIG. 3) based upon the wind speed data from the one or more meteorological stations 34, and the speed factors calculated in steps 22, 24, 26, and 27 to obtain an energy density about the location 32, for instance, as a function of height or elevation. For example, in one aspect, a well-known bin analysis is used to convert the total hours per year at each wind speed, for instance, in meters per second [m/s] and direction into wind energy density. (It will be understood by those in the art that the results from step 28 may simply comprise wind speed as a function of time and direction and/or elevation. As is known in the art, power is proportional to the cube of wind speed, and energy is equal to power multiplied by time at each speed.). Again, the bin analysis may be provided as a function of height or elevation in addition to direction.

According to one aspect of the invention, the energy density about a location, for example, about a location for consideration of a wind turbine, can be calculated by first calculating the local wind speed, S_{WL}, for example, in each wind direction, about the location. As discussed above, the wind speed can be estimated by a multiplying a reference wind speed, S_{WR}, for example, the geostrophic wind speed, S_{GW}, by the one or more speed factors discussed above, according to Equation 1.

S_{WL}=k×SF₁×SF₂×SF₃ . . . SFₙ×S_{WR} [Equation 1]

Where SF₁ . . . SFₙ may be one or more of the speed factors discussed above and k is a real number value greater than or equal to 0 and less than or equal to 1 that is a function of the particular application and/or wind turbine under consideration.

The wind energy density, E_{D}, can be calculated from the local wind speed, S_{WL}, found in Equation 1 by Equation 2.

E_{D}=½ρ(S_{WL})³×T [Equation 2]

In equation 2, E_{D} is the wind energy density, for example, in kilowatt-hours per square meter (kW-hr/m²); ρ is the density of the air under the prevailing atmospheric conditions, for example, 1.29 kg/m³; S_{WL} is the calculated local wind speed, for example, in meters per second (m/s); and T is the time at wind speed S_{WL}, for example, in wind direction under consideration, for example, in hours.

The resulting wind energy density, E_{D}, and/or speed, S_{WL}, may be provided in any conventional form, for example, in table form, in histogram by direction and/or elevation form, or in color-coded mapping of the location 32. However, in one aspect, the wind energy density and/or speed may be provided as one or more polar plots or rosettes of wind energy and/or speed based upon wind direction, for example, N, NNE, NE, ENE . . . S . . . NW, and NNW.

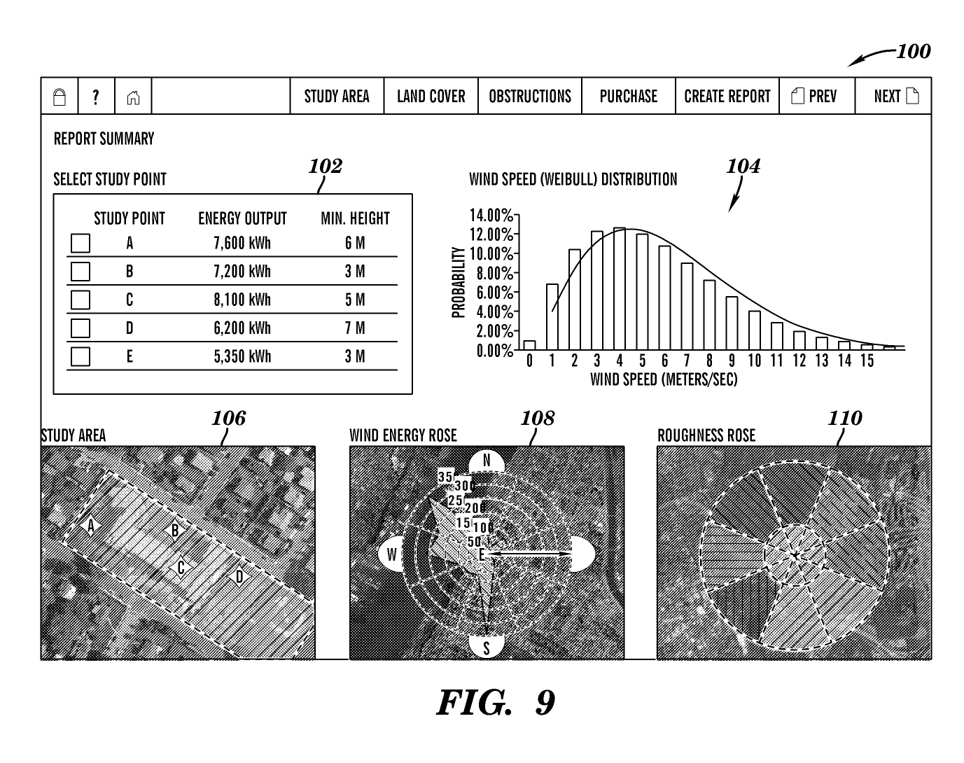

One example of an output that may be provided according to aspects of the invention is shown in FIG. 9. Though the resulting energy density, for example, as a function of direction, may be provided in any user legible form, for example, in tabulations or contour lines on a map, FIG. 9 illustrates one graphical output display 100 that may be used for aspects of the invention. As shown, output display 100, for example, an Internet-based display, may included one of a table 102 of energy output of at the “study points” (A . . . D.) at target site 32 and the minimum height at which the energy output can be expected to be provided; a probable wind speed distribution 104, for example, a Weibull distribution, of the wind speed at a study point; an overview 106 of the location of the target site 32 with the identification of study points (A . . . D); a wind energy rose 108 identifying the relative magnitudes and directions of the wind energy about target site 32; and/or a roughness rose 110 summarizing the surface roughnesses about the target site 32.

Based upon the wind energy density provided by module 18, such as, wind energy rose 108, the user 12 may use the energy density as desired, for example, as a basis for positioning one or more wind turbines at one or more study points A, B, C, or D in the location 32, or in areas about the location 32, for example, at an elevation or height, to optimize the harvesting of wind energy.

Though in one aspect of the invention, the user 12 (FIGS. 1 and 9) receives a profile of the wind speed as a function of time and direction or an energy as a function of direction, according to other aspects of the invention, user 12 may be provided with other helpful information, for example, information assisting with the citing of one or more wind turbines or other structures. For example, as indicated by step 29 in FIG. 2, in one aspect, analysis module 18 may also provide one or more of the following: wind turbine power curves, expected energy output, foundation loadings, soil structure, noise levels, incentive programs, and/or local zoning laws that may affect installation and design.

When used to provide assistance in locating wind turbines, one aspect of the invention may provide user 12 with one or more wind turbine designs, for example, one or more commercially available wind turbines (VAWT or HAWT) and the associated power or efficiency curves, for example, curves provided by the manufacture of the wind turbine. For instance, using the energy density data or speed data provided by step 28, the efficiency as a function of speed power curve may be used to determine the optimal, for example, most efficient, location, elevation, and/or direction for locating a wind turbine. In addition, with the aid of the wind energy density data and/or turbine power curves, an estimate of the expected energy that can be harvested from wind, for example, in terms of electrical energy production per year, may be provided, for example, for a specific turbine and/or for a specific turbine location.

In another aspect, module 18 may also provide assistance by estimating foundation loadings. For example, by prompting the user for suggested size and location of a structure to be installed, such as, a wind turbine, foundation loadings, both static and dynamic (including vibration), due to wind can be provided. For instance, by providing the swept area and height of the structure, such as, a wind turbine, under consideration and combining the height and swept area with the wind speed, an overturning torque or moment upon the foundation of the structure can be estimated, for example, as a function of wind direction and/or elevation. Accordingly, suggested structural supports and bolting patterns can be provided for the user's consideration.

In another aspect, module 18 may also provide soil considerations in the area 32 under consideration. Different soil or bedrock conditions in the area 32 may also impact the siting of the installation, for example, the wind turbine, and optimal locations may be proposed to user 12 based upon soil conditions. Soil information may be obtained from published data and be provided as a function of the location of area 32, for example, by longitude and latitude.

In another aspect, module 18 may also provide estimates of noise, for example, produced by a wind turbine. Based upon the wind turbine selected, aspects of the invention may provide a profile of the noise level, for example, in decibels, expected about the wind turbine, for example, in the form of noise elevation lines or “isobels” emanating from the proposed location of the wind turbine.

In still another aspect, module 18 may also provide incentives of interest to user 12, for example, federal, state, and/or local incentives for locating wind turbines, based upon location 32. Module 18 may also provide information concerning zoning laws and/or permitting requirements; again, these may be federal, state, and/or local laws and/or regulations for locating wind turbines, based upon location 32.

It is also envisioned that software tools, modeling, and/or processing, such as, computational fluid dynamics (CFD) software tools and/or mesoscale atmospheric modeling software tools, may also be incorporated into aspects of the invention, that is, to enhance the accuracy of the resulting speed and energy data.

Accordingly, aspects of the invention may provide a panoply of comprehensive alternatives to user 12 for locating an installation, such as, as a wind turbine, based upon available wind energy, suggested wind turbines, soil considerations, foundation loading, noise levels, incentives, laws, and regulations, among other things. These alternatives, both economic and engineering-related, can be provided interactively, for example, over the Internet, with results provided substantially immediately, or, after proper payment has been verified, though email or conventional mail.

As shown in FIG. 1, the user input, the data manipulated, and the results calculated by analysis module 18 may typically be communicated to storage device 42, for example, a results repository. Storage device 42 may reside in the same location as processor 16 and module 18, for example, in the same or an adjacent processor or data storage device, or may be stored remotely, for example, on a remote storage device or database. Though, in one aspect of the invention, the resulting wind energy density may be communicated from analysis module 18 to user 12, for example, via internet interface 14, in the aspect of the invention shown in FIG. 1, the results stored in storage device 42 may be transmitted to accounting module 20, for example, to ensure payment has been received, prior to transmitting the results to user 12, for example, via conventional mail or email 44.

Aspects of the present invention provide devices and methods for providing wind energy density and related ancillary information for a location, for example, for use in locating a wind turbine. Aspects of the invention may assess “micro climates,” for example, wind energies associated with turbulence, blocking, and/or speed-up, among other factors, about natural and man-made structures. As will be appreciated by those skilled in the art, features, characteristics, and/or advantages of the various aspects described herein, may be applied and/or extended to any embodiment (for example, characterizes or features of one aspect or embodiment may be applied and/or extended to any aspect, embodiment, or portion thereof disclosed herein).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for locating a wind turbine comprising:
a) providing a location for consideration for locating a wind turbine;
b) identifying at least one meteorological station;
c) determining a wind speed for the at least one meteorological station;
d) determining surface roughness characteristics of an area around the at least one meteorological station;
e) calculating a geostrophic wind speed about the at least one meteorological station from the wind speed for the at least one meteorological station and the surface roughness characteristics of an area around the at least one meteorological station;
f) determining surface roughness characteristics of an area around the location;
g) calculating a wind speed for the area about the location from the calculated geostrophic wind speed and the surface roughness characteristics of the area around the location; and
h) locating the wind turbine at a position in the area of the location based upon the calculated wind speed for the area about the location to optimize exposure of the wind turbine to wind speed.

2. The method as recited in claim 1, wherein the method further comprises calculating a wind energy density for the area about the location from the calculated wind speed, and locating the wind turbine at a position in the area of the location based upon the calculated wind energy density to optimize exposure of the wind turbine to wind energy.

3. The method as recited in claim 1, wherein the method further comprises, after f), i) determining a local wind speed correction factor, and wherein g) comprises calculating the wind speed from the calculated geostrophic wind speed, the surface roughness characteristics, and the local wind speed correction factor.

4. The method as recited in claim 3, wherein the local wind speed correction factor is calculated from consideration of at least one of local natural and local man-made structures.

5. The method as recited in claim 4, wherein the local wind speed correction factor calculated from consideration of at least one of local natural and man-made structures comprises upwind wake consideration of the structures.

6. The method as recited in claim 1, wherein a) is provided by automated means.

7. The method as recited in claim 6, wherein the automated means comprises distributed processors.

8. The method as recited in claim 7, wherein the distributed processors comprise the Internet.

9. The method as recited in claim 2, wherein the method further comprises, after g), j) displaying the calculated wind energy density for the area about the location.

10. The method as recited in claim 9, wherein the displaying the calculated wind energy density in the area about the location comprises displaying the wind energy density in the area about the location as a polar energy density distribution plot.

11. The method as recited in claim 1, wherein the method further comprises providing at least one of a wind turbine power curve, a foundation loading, a soil structure, a noise level, an incentive programs, and a local zoning law.

12. A system for locating a wind turbine comprising:
a user interface for providing a location for consideration for locating a wind turbine;
means for identifying at least one meteorological station;
means for determining a wind speed for the at least one meteorological station;
means for determining surface roughness characteristics of an area around the at least one meteorological station;
a data processor programmed to calculate a geostrophic wind speed about the at least one meteorological station from the wind speed and the surface roughness characteristics of an area around the at least one meteorological station;
means for determining surface roughness characteristics of an area around the location;
a data processor programmed to calculate a wind speed in the area about the location from the calculated geostrophic wind speed and the surface roughness characteristics of the area around the location; and
means for locating the wind turbine at a position in the area of the location to optimize exposure of the wind turbine to calculated wind speed.

13. The system as recited in claim 12, wherein the system further comprises means for calculating a wind energy density for the area about the location from the calculated wind speed, and wherein the means for locating the wind turbine comprises means for locating the wind turbine at a position in the area of the location based upon the calculated wind energy density to optimize exposure of the wind turbine to wind energy.

14. The system as recited in claim 12, wherein the system further comprises means for determining a local wind speed correction factor, and wherein the data processor is programmed to calculate a wind speed in the area about the location from the calculated geostrophic wind speed, the surface roughness characteristics of the area around the location, and a local wind speed correction factor.

15. The system as recited in claim 14, wherein the local wind speed correction factor is calculated from consideration of at least one of local natural structure and local man-made structure.

16. The system as recited in claim 15, wherein the local wind speed correction factor calculated from consideration of at least one of local natural and local man-made structures comprises upwind wake consideration of the structures.

17. The system as recited in claim 12, wherein the user interface comprises an automated user interface.

18. The system as recited in claim 17, wherein the automated an automated user interface comprises distributed processors.

19. The system as recited in claim 18, wherein the distributed processors comprise the Internet.

20. The system as recited in claim 13, wherein the system further comprises an output means configured to display the calculated wind energy density for the area about the location.

21. The system as recited in claim 20, wherein the output means comprises a means for displaying the wind energy density in the area about the location as a polar energy density distribution plot.

22. The system as recited in claim 12, wherein the system further comprises at least one of means for providing a wind turbine power curve, means for providing a foundation loading, means for providing a soil structure, means for providing a noise level, means for providing an incentive program, and means for providing a local zoning law.

23. A method for providing wind energy density for a location, the method comprising:
a) providing a location for consideration;
b) identifying at least one meteorological station;
c) determining a wind speed for the at least one meteorological station;
d) determining surface roughness characteristics of an area around the at least one meteorological station;
e) calculating a geostrophic wind speed about the at least one meteorological station from the wind speed for the at least one meteorological station and the surface roughness characteristics of an area around the at least one meteorological station;
f) determining surface roughness characteristics of an area around the location; and
g) calculating a wind energy density for the area about the location from the calculated geostrophic wind speed and the surface roughness characteristics of the area around the location.

24. The method as recited in claim 23, wherein the method further comprises, after f), i) determining a local wind speed correction factor, and wherein g) comprises calculating the wind energy density from the calculated geostrophic wind speed, the surface roughness characteristics and the local wind speed correction factor.

25. The method as recited in claim 24, wherein the local wind speed correction factor is calculated from consideration of at least one of a local natural structure and a local man-made structure.

26. The method as recited in claim 23, wherein the local wind speed correction factor calculated from consideration of at least one of the local natural structure and the local man-made structure comprises upwind wake consideration of the structure.

27. The method as recited in claim 23, wherein a) is provided by automated means.

28. The method as recited in claim 27, wherein the automated means comprises distributed processors.

29. The method as recited in claim 28, wherein the distributed processors comprise the Internet.

30. The method as recited in claim 23, wherein the method further comprises, after g), h) displaying the calculated wind energy density for the area about the location.

31. The method as recited in claim 30, wherein the displaying the calculated wind energy density in the area about the location comprises displaying the wind energy density in the area about the location as a polar energy density distribution plot.

32. The method as recited in claim 23, wherein the method further comprises providing at least one of a wind turbine power curve, a foundation loading, a soil structure, a noise level, an incentive program, and a local zoning law.

33. A system for providing wind energy density for a location, the system comprising:
a user interface for providing a location for consideration;
means for identifying a meteorological station;
means for determining a wind speed for the meteorological station;
means for determining surface roughness characteristics of an area around the meteorological station;
a data processor programmed to calculate a geostrophic wind speed about the at least one meteorological station from the wind speed and the surface roughness characteristics of an area around the at least one meteorological station; and
means for determining surface roughness characteristics of an area around the location;
a data processor programmed to calculate a wind energy density in the area about the location from the calculated geostrophic wind speed factor and the surface roughness characteristics of the area around the location.

34. The system as recited in claim 33, wherein the system further comprises means for determining a local wind speed correction factor, and wherein the data processor is programmed to calculate a wind energy density in the area about the location from the calculated geostrophic wind speed, the surface roughness characteristics of the area around the location, and the local wind speed correction factor.

35. The system as recited in claim 34, wherein the local wind speed correction factor is calculated from consideration of at least one of a local natural structure and a local man-made structure.

36. The system as recited in claim 35, wherein the local wind speed correction factor calculated from consideration of at least one of the local natural structure and the local man-made structure comprises upwind wake consideration of the structure.

37. The system as recited in claim 33, wherein the user interface comprises an automated user interface.

38. The system as recited in claim 37, wherein the automated an automated user interface comprises distributed processors.

39. The system as recited in claim 38, wherein the distributed processors comprise the Internet.

40. The system as recited in claim 33, wherein the system further comprises an output means configured to display the calculated wind energy density for the area about the location.

41. The system as recited in claim 40, wherein the output means comprises a means for displaying the wind energy density in the area about the location as a polar energy density distribution plot.

42. The system as recited in claim 33, wherein the system further comprises at least one of means for providing a wind turbine power curve, means for providing a foundation loading, means for providing a soil structure, means for providing a noise level, means for providing an incentive program, and means for providing a local zoning law.

43. The method as recited in claim 8, wherein a) providing a location for consideration for locating a wind turbine comprises providing an Internet-accessible user interface for identifying the location.

44. The method as recited in claim 43, wherein providing the Internet-accessible user interface comprises providing a user-movable cursor adapted to identify the location on a map.

45. The system as recited in claim 19, wherein the automated user interface comprises an Internet-accessible user interface for identifying the location.

46. The system as recited in claim 45, wherein Internet-accessible user interface comprises a user-movable cursor adapted to identify the location on a map.
